(19) United States
(12) Patent Application Publication
(10) Pub. No.: US 2012/0209663 A1
(43) Pub. Date: Aug. 16, 2012

(54) ADOPTING AND/OR OPTIMIZING THE USE OF MOBILE TECHNOLOGY

(75) Inventors: William Darrell GASKINS, JR., Washington, DC (US); Christopher GORMAN, Falls Church, VA (US); Kelly O'CONNOR, Washington, DC (US)

(73) Assignee: EFIIA CREATIONS LLC, Washington, DC (US)

(21) Appl. No.: 13/396,475

(22) Filed: Feb. 14, 2012

Related U.S. Application Data
(60) Provisional application No. 61/443,242, filed on Feb. 15, 2011.

(51) Int. Cl. G06Q 10/06

(52) U.S. Cl. 705/7.36

(57) ABSTRACT

A method is implemented in a computer infrastructure having computer executable code tangibly embodied on a computer readable storage medium having programming instructions. The programming instructions are operable to assess a current mobile technology baseline for a business using a tool or application and a processor. Additionally, the programming instructions are operable to provide a strategy to the business for at least one of adopting and optimizing the use of mobile technology.

### CROSS REFERENCE TO RELATED APPLICATION

This application claims the priority of U.S. Provisional Application No. 61/443,242 filed Feb. 15, 2011, the contents of which are incorporated by reference herein in their entirety.

### FIELD OF THE INVENTION

The present invention generally relates to adopting and/or optimizing the use of mobile technology, and more particularly, to systems and methods for enabling businesses to adopt and/or optimize the use of mobile technology in the workplace to achieve cost savings, improved efficiencies, and improved customer support.

### BACKGROUND

The use of mobile technology is a driving force in commerce and business. For example, mobile technology influences content and document management, e-commerce, planning and execution of projects, as well as the general dissemination of information, to name a few. In commerce and business, the globalization of work through mobile technology has transformed commerce and the workplace into a ubiquitous landscape with less reliance on physical location and more emphasis on customer and resource access. As the Internet and other mobile technologies evolve and become an ever more important tool for businesses to increase revenue and reduce costs, many businesses have begun to assess and optimize their use of such mobile technologies.

In general, any type of technology adoption and use thereafter tends to follow a standard bell curve with a minority of businesses embracing technology in its earlier stages, while another minority only reluctantly embraces such technology when it is mature. Businesses are often looking for a quick approach to assess where they lie on the technology adoption curve to help them determine when a new technology adoption should occur and/or what new technology should be adopted and used.

For example, the evaluation of adoption and use of mobile devices in the workplace has traditionally focused on examining the impact of mobile technology on social interaction, context, usage, and design. To this end, evaluators have traditionally manually compared and contrasted the benefits and drawbacks of a business adopting and using mobile technology using unstructured methodologies. For example, the benefits of adopting and utilizing mobile technology in the workplace includes improvements to the services a business may offer their customers, the ability to reach a larger population of potential customers, and greater flexibility in working and training. On the other hand, the drawbacks of adopting and utilizing mobile technology in the workplace include the costs involved in purchasing and setting up the equipment and software, the training required to make use of mobile technology by employees and customers, and the potential exposure of valuable data to unauthorized people. Once these various benefits and drawbacks are investigated and compared, a business may make a decision on whether to adopt and use the mobile technology in the workplace.

Additionally, either during the adoption evaluation phase discussed above, or once the business has decided to adopt and use the mobile technology, a supplemental or additional assessment may be performed in order to maximize or optimize use of new or already implemented mobile technology. However, if the supplemental or additional assessment for optimization is performed at all, it is also traditionally performed as a manual process using unstructured methodologies. In particular, finding the optimal mobile technology workplace strategy from a vast range of mobile technology strategies available presents a substantial challenge for businesses.

Accordingly, there exists a need in the art to overcome the deficiencies and limitations described herein above.

### SUMMARY

In a first aspect of the invention, a method is implemented in a computer infrastructure having computer executable code tangibly embodied on a computer readable storage medium having programming instructions. The programming instructions are operable to assess a current mobile technology baseline for a business using a tool or application and a processor. Additionally, the programming instructions are operable to provide a strategy to the business for at least one of adopting and optimizing the use of mobile technology.

In an additional aspect of the invention, a computer program product comprising a computer usable storage medium having readable program code embodied in the medium is provided. The computer program product includes at least one component operable to assess a current mobile technology baseline for a business and provide a strategy to the business for at least one of adopting and optimizing the use of mobile technology.

In a further aspect of the invention, a computer system for at least one of modeling and forecasting technology adoption, the system comprises a CPU, a computer readable memory and a computer readable storage media. Additionally, the system comprises first program instructions to assess a current mobile technology baseline for a business. Further, the system comprises second program instructions to a strategy to the business for at least one of adopting and optimizing the use of mobile technology. The first and second program instructions are stored on the computer readable storage media for execution by the CPU via the computer readable memory.

In a further aspect of the invention, a method is provided comprising the step of receiving a communication expressing interest from a business with respect to implementing or optimizing a mobile technology. The method further comprising the step of implementing a first tool using a processor to rapidly assess a business's mobile application initiative and generate a best practices report. The method further comprising the step of implementing a second tool using the same processor or another processor to obtain a baseline maturity level for the business and generate a report that includes baselines, findings, and recommendations for implementing or optimizing the mobile technology. The method further comprising the step of executing the recommendations. The method further comprising the step of implementing a third tool to perform an extensive assessment of the business's mobile requirements. The method further comprising the step of developing a mobile strategy and implementation plan utilizing a fourth tool. The method further comprising the step of measuring performance of the developed mobile strategy using the fourth tool.

### BRIEF DESCRIPTION OF THE SEVERAL VIEWS OF THE DRAWINGS

The present invention is described in the detailed description, which follows, in reference to the noted plurality of drawings by way of non-limiting examples of exemplary embodiments of the present invention.

FIG. 1 is an illustrative external environment for implementing the invention in accordance with aspects of the invention;

FIG. 2 is an illustrative process flow of implementing the invention in accordance with aspects of the invention; and

FIGS. 3-11 show a series of illustrative functions of the invention in accordance with aspects of the invention.

### DETAILED DESCRIPTION

The present invention generally relates to adopting and/or optimizing the use of mobile technology, and more particularly, to systems and methods for enabling businesses to adopt and/or optimize the use of mobile technology in the workplace to achieve cost savings, improved efficiencies, and improved customer support. In embodiments, the approach of the present invention utilizes an adoption and/or optimization model that provides a framework and methodology for enabling a business (e.g., enterprises or firms that are public organizations, private organizations, or both engaged in the trade of goods, services, or both to consumers) to take a structured and transparent approach to planning and budgeting for mobile technology solutions.

Specifically, the approach of the present invention enables a business to align mission objectives to mobile excitement and the proliferation of pilots, build business case(s) and realize returns on investment, establish pre-application development cross-organizational stakeholder consensus on major issues, fast track requirements analysis for acquisition planning, discuss device native and consumer off the shelf (COTS) security and privacy options relative to budget, target user base, and data classification level, review or modify development lifecycle for mobile in conjunction with security certification and accreditation, and authority to operate (ATO) gate reviews, establish measurable performance metrics and relevant reporting, and prepare capital planning and business case documentation for a budget cycle to secure funding for sustainment and new mobile initiatives.

In embodiments, the approach of the present invention comprises a collection of statistical data structures and/or computer programs, e.g., tools or applications, which enable the business to adopt and optimize the use of mobile technology in an efficient manner that provides the business with cost savings, internal operational effectiveness, and customer satisfaction. For example, tools or applications of the present invention may be utilized to identify areas within a business that would benefit from the use of mobile technology in terms of high return on investment or cost savings, start a dialogue among users within the business to define mobile goals, objectives and requirements, provide a foundation for a business's mobile strategy by establishing an immediate understanding of the business's maturity level, objectives, user requirements, performance metrics, and next steps, and ensure that mobile computing supports the business's mission and saves the business money. Advantageously, the approach of the present invention allows for a business to collect, prioritize, and analyze business, functional, and/or technical requirements that could be supplemented or optimized through the use of mobile technology at a faster rate and more cost effective.

### System Environment

As will be appreciated by one skilled in the art, the approach of the present invention may be embodied as a system, method, or computer program product. Accordingly, the approach of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, the approach of the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider).

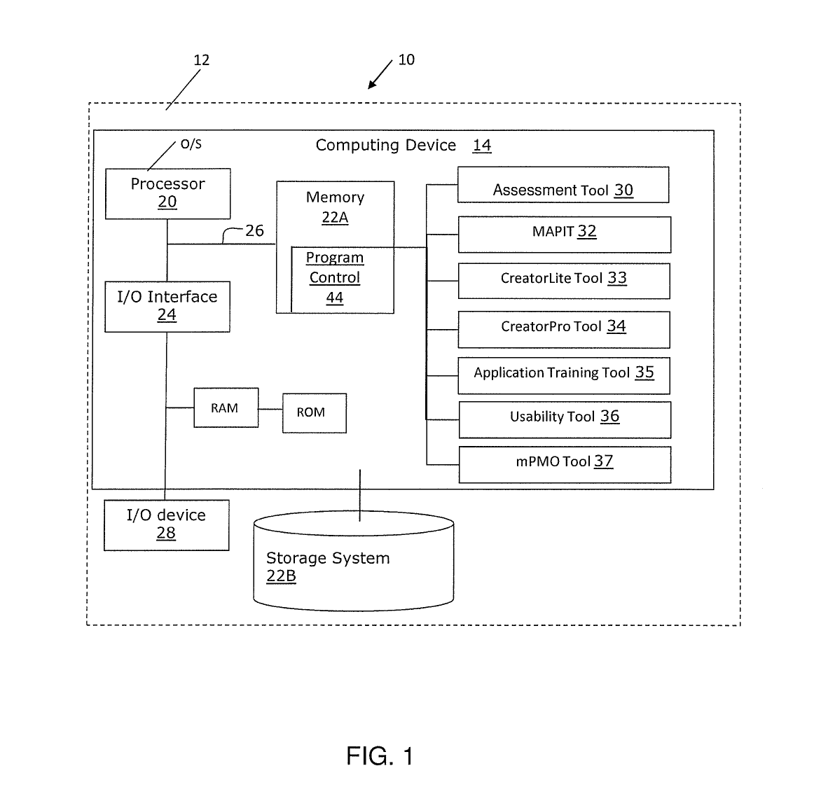

FIG. 1 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S). The memory (e.g., 22A) may store business intelligence, data mining, regression analysis and/or modeling and simulation tools for execution by the processor 20.

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

In general, the processor 20 executes computer program code (e.g., program control 44), which can be stored in the memory 22A and/or storage system 22B. Moreover, in accordance with aspects of the invention, the program control 44 controls one or more of an assessment tool 30, a mobile acquisition prioritization investment technique (MAPIT) tool 32, CreatorLite tool 33, CreatorPro tool 34, a mobile application development training tool 35, a usability tool 36, and a mobile program management office (mPMO) tool 37. The assessment tool 30, the MAPIT tool 32, the CreatorLite tool 33, the CreatorPro application 34, the mobile application development training tool 35, the usability tool 36, and the mPMO tool 37 can be implemented as one or more program code in the program control 44 stored in memory 22A as separate or combined modules. Additionally, the assessment tool 30, the MAPIT tool 32, the CreatorLite tool 33, the CreatorPro tool 34, the mobile application development training tool 35, the usability tool 36, and the mPMO tool 37 may be implemented as separate dedicated processors or a single or several processors to provide the function of these tools. While executing the computer program code, the processor 20 can read and/or write data to/from memory 22A, storage system 22B, and/or I/O interface 24. The program code executes the processes of the invention. The bus 26 provides a communications link between each of the components in the computing device 14.

The computing device 14 can comprise any general purpose computing article of manufacture capable of executing computer program code installed thereon (e.g., a personal computer, laptop computer, tablet computer, server, personal digital assistant (PDA), cell phone, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network (WAN), a local area network (LAN), a virtual private network, etc.); and/or utilize any combination of transmission techniques and protocols.

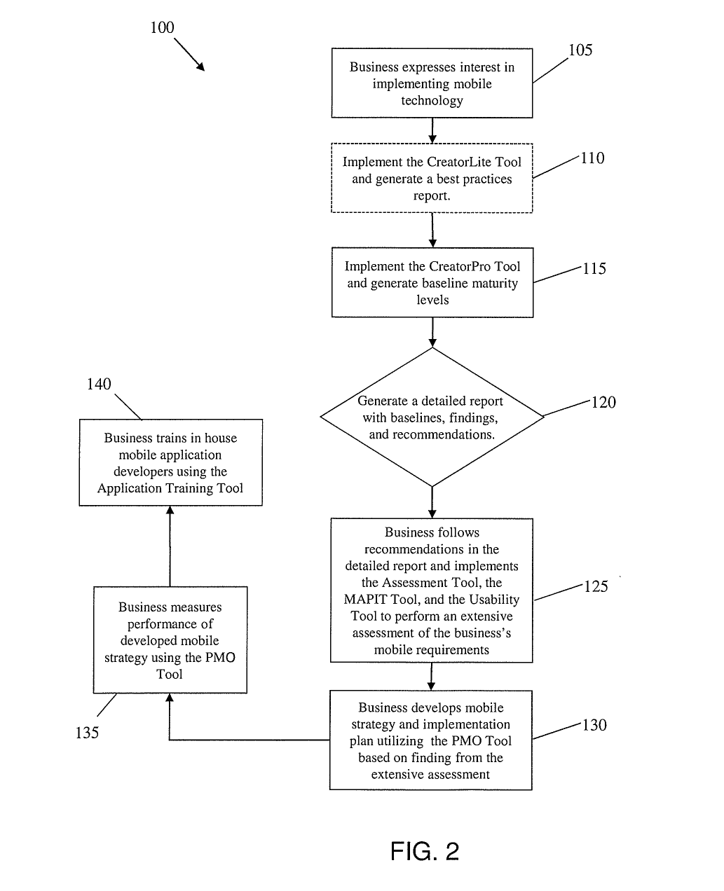

The assessment tool 30 comprises a number of predefined questions and weightings that enable a business to identify requirements of the business, e.g., business, functional, or technical requirements and obtain an immediate understanding of the business's maturity level, objectives, user requirements, and performance metrics. The predefined questions may also enable the business to understand current use of mobile solutions within the business, understand future and projected costs of the requirements, and identify requirements that could benefit from mobile technology solutions, for example, as illustrated in FIGS. 2-10, e.g., the processes described herein. The MAPIT tool 32 is a requirements prioritization tool that uses defined criteria in a standard framework, e.g., a 4 quadrant framework, to enable a business to prioritize requirements based on technical complexity and customer value, for example, as illustrated in FIGS. 2-10, e.g., the processes described herein. The CreatorLite tool 33 and the CreatorPro tool 34 are applications that help business project managers and IT leaders plan and execute mobile projects more effectively, for example, as illustrated in FIGS. 2-10, e.g., the processes described herein. The mobile application development training tool 35 enables businesses to build-in house mobile development expertise and capabilities, for example, as illustrated in FIGS. 2-10, e.g., the processes described herein. The usability tool 36 comprises a subcollection of tools including usability tests, scorecards, and best practice tips to increase ease of use for mobile technology solutions, for example, as illustrated in FIGS. 2-10, e.g., the processes described herein. The mPMO tool 36 is configured to operate as a package tool comprising, for example, the application tool 30, the MAPIT tool 32, and/or the usability tool 36, or as a standalone tool that is operable to offer support to businesses with effective management and ongoing performance improvement of mobile initiatives, for example, as illustrated in FIGS. 2-10, e.g., the processes described herein.

### Flow Diagram

FIG. 2 shows an exemplary flow for performing aspects of the present invention. The steps of FIG. 2 may be implemented in the environment of FIG. 1, for example. The flow diagram may equally represent a high-level block diagram or a swim-lane diagram of the invention. The flowchart and/or block diagram in FIG. 2 illustrates the architecture, functionality, and operation of possible implementations of systems, methods and computer program products according to various embodiments of the present invention. In this regard, each block in the flowchart, block diagram or swim-lane diagram may represent a module, segment, or portion of code, which comprises one or more executable instructions for implementing the specified logical function(s). It should also be noted that, in some alternative implementations, the functions noted in the blocks may occur out of the order noted in the figure. For example, two blocks shown in succession may, in fact, be executed substantially concurrently, or the blocks may sometimes be executed in the reverse order, depending upon the functionality involved. Each block of each flowchart, and combinations of the flowchart illustration can be implemented by special purpose hardware-based systems that perform the specified functions or acts, or combinations of special purpose hardware and computer instructions and/or software, as described above. Moreover, the steps of the flow diagram may be implemented and executed from either a server, in a client server relationship, or they may run on a user workstation with operative information conveyed to the user workstation. In an embodiment, the software elements include firmware, resident software, microcode, etc.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses mobile technology. In return, the service provider can receive payment from the customer(s) under a subscription and/or fee agreement and/or the service provider can receive payment from the sale of advertising content to one or more third parties.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 2 depicts an exemplary flow 100 for a process in accordance with aspects of the present invention. One of ordinary skill in the art would understand the steps of the following flow might vary depending on where a business is in terms of maturity in implementing mobile technology solutions within the business. More specifically, exemplary flow 100 illustrates a sample based on a business that does not currently have a mobile technology strategy or implementation plan. As shown in FIG. 1, at step 105 the process starts by a business expressing interest in implementing and/or optimizing a mobile solution, e.g., development of a mobile application, based on mission needs and/or a need to save money through the use of mobile technology. The interest may be expressed by the business contacting a service provider. For example, contact and interest may be affected by the business downloading a tool or application provided and supported by the service provider, e.g., CreatorLite tool 33 or CreatorPro tool 34, from a web site and completing a registration process.

At step 110, the business may obtain and/or utilize the tool or application provided and supported by the service provider, which enables the business to obtain a best practices report for implementing and/or optimizing the mobile technology solution within the business. For example, the business may download the CreatorLite tool 33 from a web site, e.g., the Apple Store or the Android Market, onto a computing device 14. The CreatorLite tool 33 is configured to provide a quick assessment and recommendations for mobile application development projects based on a comprehensive mobile methodology and framework. Specifically, upon operation of the CreatorLite tool 33, the tool is configured to provide an assessment of a business's mobile application initiative by presenting the business with a predetermined number of questions, analyzing the answers provided to the questions by the business, and generating a report that highlights relevant best practices and risks. Step 110 is optional, which means that either the step is performed in accordance with the approach of the present invention or the step is not performed in accordance with the approach of the present invention.

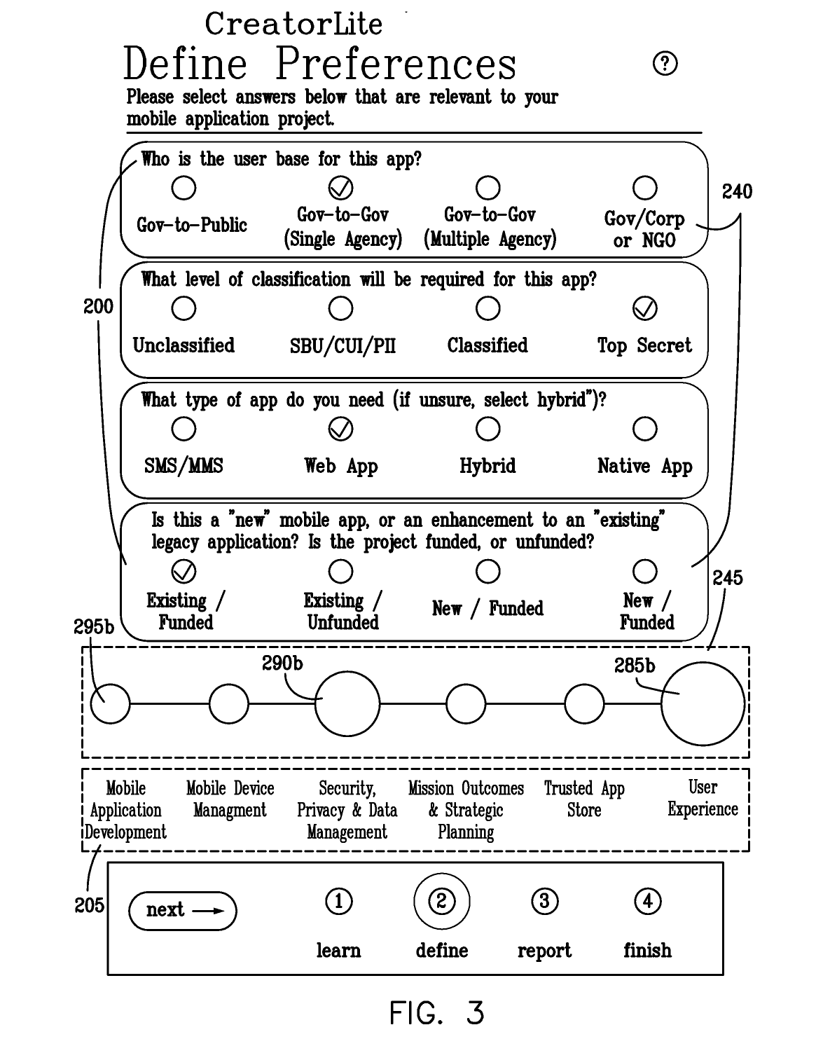

As shown in FIG. 3, the CreatorLite tool 33 is configured to present questions 200 to the business that relate to functional categories or areas 205 of a mobile framework used to rapidly assess the business's mobile application initiative. For example, the categories or areas 205 may include: (i) user experience; (ii) security, privacy, and data management; (iii) mission outcomes and strategic planning; (iv) mobile device management; (v) mobile application development; and (vi) trusted application stores. Each area or category may comprise best practices, risks, and relative levels of effort.

As shown in FIG, 4, the CreatorLite tool 33 may be configured to display the best practices, risks, and relative levels of effort related to each category or area such that the business can efficiently review and obtain an understanding of each category or area of the mobile framework. In embodiments, the CreatorLite tool 33 may also be configured to provide a notes area 215 and a relative importance indicator 220. The notes area 215 may be utilized by the business for taking notes regarding each category or area of the mobile framework. The notes may be stored and then later retrieved and referenced via the generated report. The relative importance indicator 220 provides an indication of the importance of user experience for achieving the business's mobile application initiative. The importance indicator reflects weights that are applied to the answers provided by the business to the questions, as discussed above and in further detail below.

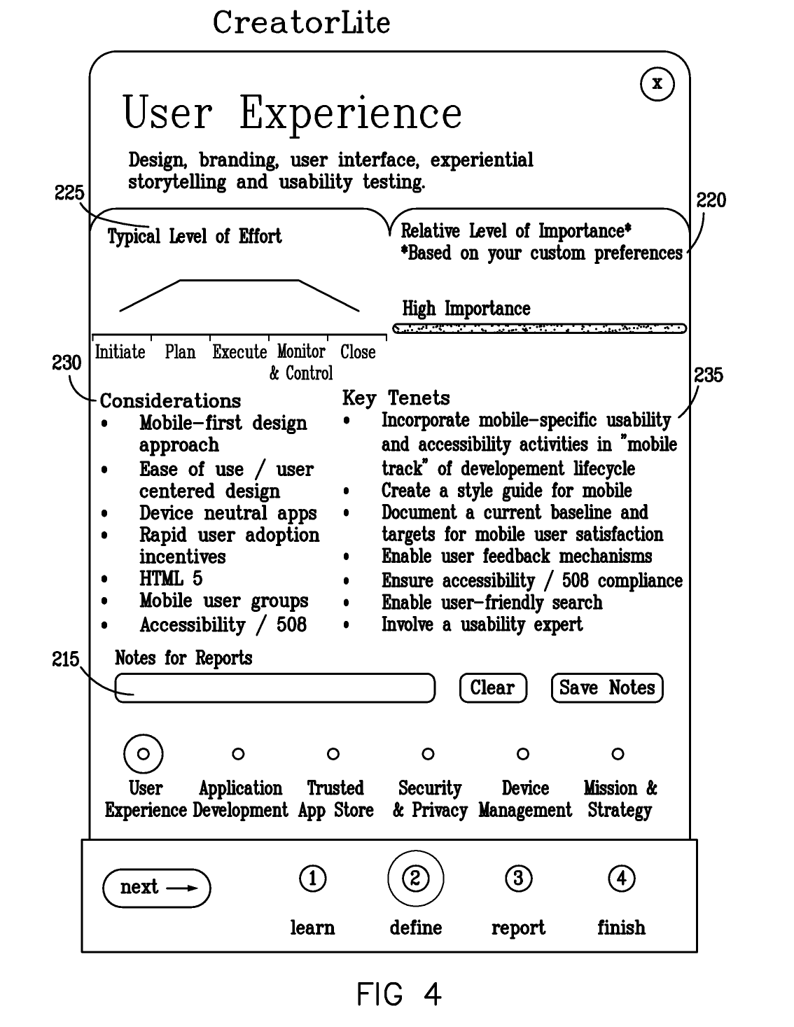

As also shown in FIG. 4, user experience pertains to design, branding, user interface experiential storytelling, and usability testing. Typical levels of effort 225 required for achieving user experience may be displayed in a graph that spans a period of time for the mobile application initiative starting from the point of initiation of the mobile application through planning, execution, monitoring and control, and ending at closure of the application initiative. Best practices and risks relevant to user experience may comprise considerations 230 and key tenets 235. For example, the considerations 230 may include mobile-first design approach, ease of use/user centered design, device neutral applications, rapid user adoption incentives, HTML 5, mobile user groups, and accessibility. Key tenets 235 may include incorporating mobile-specific usability and accessibility activities in “mobile track” of development lifecycle, creating a style guide for mobile, documenting a current baseline and targets for mobile user satisfaction, enabling user feedback mechanisms, ensuring accessibility, enabling a user friendly search, involving a usability expert, and taking a user-centered development approach.

In accordance with aspects of the invention, security, privacy, and data management pertains to acceleration of security certification and accreditation while maintaining compliance through optimizing data management and information sharing. As discussed above with respect to FIG. 4, typical levels of effort 225 required for achieving security, privacy, and data management may be displayed in a graph that spans a period of time for the mobile application initiative. Best practices and risks relevant to security, privacy, and data management may comprise considerations 230 and key tenets 235. For example, the considerations 230 may include certification and accreditation, remote data wipe, mobile security and privacy policies, mobile data management policies, and existing system boundaries. Key tenets 235 may include updating security controls to align with evolving technologies and platforms, leveraging web applications with existing system boundaries, modifying development lifecycle “mobile track” for expedited ATO and certification and accreditation (C&A) processes, evaluating risks and threats (that were at one point in time an issue on a particular platform) against a new platform, defining mobile-specific security requirements for data, device and applications, developing risk based controls from a blank slate, updating security controls to align with evolving technologies and platforms, determining hosting strategies, defining device certification requirements, defining remote data wipe requirements, establishing a lost device hotline, defining mobile continuity of operations plan/disaster recovery (COOP/DR) requirements, and determining use of data at rest versus data in motion.

In accordance with aspects of the invention, mission outcomes and strategic planning pertains to creating a business mobile technology solution that optimizes resources, improves mission performance, and increases internal efficiencies. As discussed above with respect to FIG. 4, typical levels of effort 235 required for achieving mission outcomes and strategic planning may be displayed in a graph that spans a period of time for the mobile application initiative. Best practices and risks relevant to mission outcomes and strategic planning may comprise considerations 230 and key tenets 235. For example, the considerations 230 may include business mobile strategy, mobile policies and legislative mandates, business process redesign, risk management, performance tracking, assessment, and improvement, mobile workforce/training/change in management, ecosystem value chain, mobile business case return on investment/capital planning and investment control (ROI/CPIC) alignment, funding model (e.g., shared service, fee for service), mobile program management office, and mobile performance baseline and targets. Key tenets 235 may include developing a business strategy and plan for mobile, taking advantage of economies of scale with device and license purchasing, conducting a total cost of ownership analysis based on long-term plan, rationalizing hundreds of mobile use cases into a coherent business roadmap, avoiding proliferation of pilots, identifying mobile policy gaps early, developing, communicating and enforcing mobile device usage and application usage policies, ensuring IT organization can support current and anticipated mobile users, and enabling a “lost device” hotline.

In accordance with aspects of the invention, mobile device management pertains to providing for effective budgeting, procuring, provisioning, managing, and retiring mobile devices. As discussed above with respect to FIG. 4, typical levels of effort 235 required for achieving mobile device management may be displayed in a graph that spans a period of time for the mobile application initiative. Best practices and risks relevant to mobile device management may comprise considerations 230 and key tenets 235. For example, the considerations 230 may include device procurement, device provisioning, device management, device approval for use on network, employee owned device versus business owned devices, device security, device business case/total cost of ownership analysis, device requirements (e.g., durability), device operations and maintenance (O&M)/refresh, device acquisition time frames, device registration, device inventory, location services, user notification, 24/7 device monitoring, device performance service level agreement (SLA), budget/CPIC process, device retirement, device refresh, and a proven mobile device management (MDM) provider. Key tenets 235 may include centralizing mobile device acquisition processes, exploiting multiple uses of mobile devices, defining extensible hardware/sled requirements, defining requirements for mobile device provisioning, security, training, user support and O&M, developing an end-to-end device provisioning process, selecting vendors with proven mobile solutions, developing a business mobile plan that takes advantage of economies of scale for device purchasing, and anticipating policy requirements to update device usage policies.

In accordance with aspects of the invention, mobile application development pertains to the full lifecycle of mobile application development and deployment activities. As discussed above with respect to FIG. 4, typical levels of effort 235 required for achieving mobile application development may be displayed in a graph that spans a period of time for the mobile application initiative. Best practices and risks relevant to mobile application development may comprise considerations 230 and key tenets 235. For example, the considerations 230 may include web application versus native application versus hybrid applications, pilot transition to production, scalability, interoperability, and device neutral applications. Key tenets 235 may include developing a “mobile track” of your development lifecycle, reducing time to market, focusing on user experience, enabling rapid adoption, understanding mobile-specific detailed requirements, using storyboards, wireframes and user stories, defining mobile access and usage policies, taking a user-centered development approach, distilling to core feature sets, and designing device neutral applications.

In accordance with aspects of the invention, trusted application stores pertain to secure, anytime, anywhere access to applications. As discussed above with respect to FIG. 4, typical levels of effort 235 required for achieving trusted application stores may be displayed in a graph that spans a period of time for the mobile application initiative. Best practices and risks relevant to trusted application stores may comprise considerations 230 and key tenets 235. For example, the considerations 230 may include licensing and legal constraints for application provisioning, rationalize “buy versus build” application store approach, web application versus native application versus hybrid applications, and secure application provisioning, business application store versus third party application store. Key tenets 235 may include developing ensuring appropriate in-house review and oversight of application branding, defining mobile-specific requirements for application provisioning, security, training, user support, and O&M, and developing an end-to-end application provisioning process.

As shown in FIG. 3, the questions 200 presented to the business for rapidly assessing the business's mobile application initiative may include requesting: (i) who the user base is for the potential mobile application; (ii) what level of security classification will be required for the mobile application; (iii) what type of application would be required, e.g., short message service (SMS)/multimedia messaging service (MMS), Web Application, Hybrid, or Native Application; and (iv) whether the mobile application is a new mobile application or an enhancement to an “existing” legacy application and whether the mobile application project is funded or unfunded. Although four examples of questions are provided above, it should be understood that any number and type of questions might be used so long as the questions are relatable to the mobile framework being utilized to rapidly assess the business's mobile strategy.

As further shown in FIG. 3, the CreatorLite tool 33 may be configured to change the relative importance of each of the functional categories or areas of a mobile framework based on the answers 240 provided to the questions 200 by the business. The changes in relative importance may then be reflected in the generated report. For example, the computing device 14 may display the questions 200 in a sequential order, and at the bottom of the display, each of the functional categories or areas 205 of a mobile framework may be listed with a corresponding object 245, e.g., a circle, which is configured to change sizes based on the answers 240 provided to the questions. The circle may become bigger to signify the area as becoming more important to the mobile application strategy or may become smaller to signify the area as becoming less important to the mobile application strategy. The relative importance of each of the functional categories or areas 205 may be calculated as an ongoing process as the business answers the questions such that the business can realize the change in importance of their answers 240 for each category or area 205 in real time by viewing the dynamic change in the size of the object 245, or the relative importance may be calculated after the business has answered all of the questions in order to provide only a final relative importance for each category or area 205.

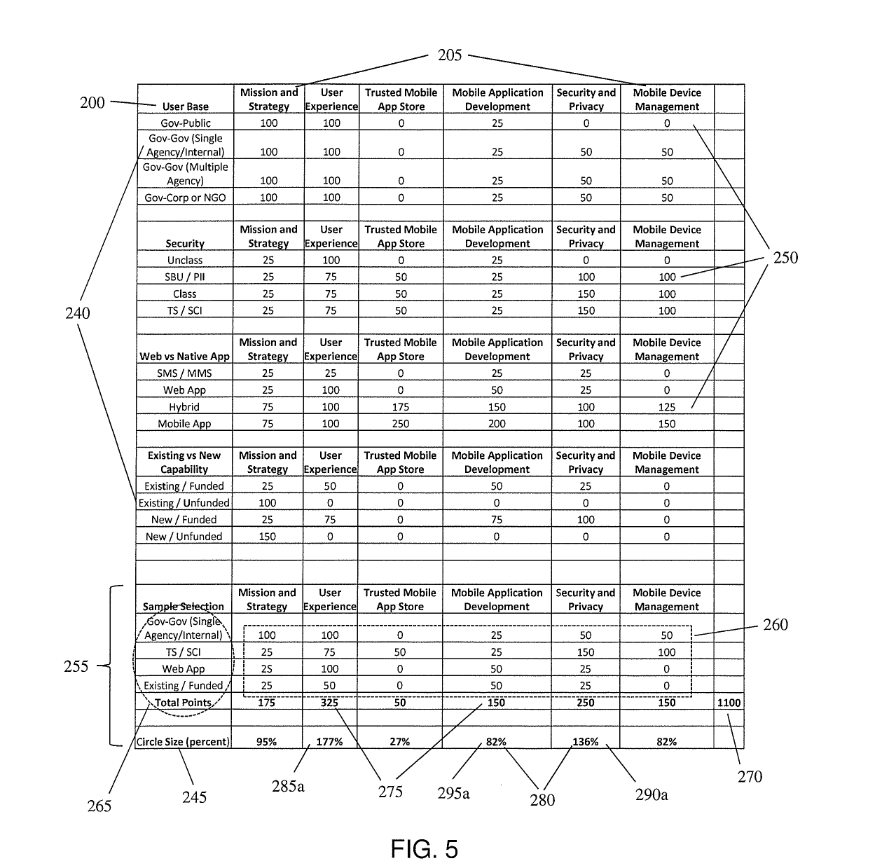

In embodiments, the CreatorLite tool 33 may be configured to calculate the relative importance of each of the functional categories or areas 205 of the mobile framework by utilizing a database and/or an algorithm. For example, as shown in FIG. 5, each possible answer 240 to questions 200 may be provided predefined corresponding weights 250 for each of the functional categories or areas 205 of the mobile framework. The weights 250 provide an indication of the relative importance of that answer 240 to each of the functional categories or areas 205. As shown in the sample selection area 255, the weights 260 corresponding to selected answers 265 by the business may be summed for all of the functional categories or areas 205 to calculate a total weighted score 270 for the mobile application initiative. Additionally, the weights 260 corresponding to selected answers 265 may be summed for each individual functional category or area 205 to calculate a total categorical weighted score 275. Each total categorical weighted score 275 is then divided by the total weighted score 270 and multiplied by a predetermined number (e.g., ((categorical weighted score 345/total weighted score 340)*6), the predetermined number may for example be the number of individual functional categories or areas 205) to arrive at a relative percentage value 280 for each individual functional category or area 205 of the mobile framework.

The relative percentage values 280 are relative to each other, and thus may be used to change the sizes of the object 245, as discussed above with respect to FIG. 3. For example, the relative percentage value 285a for User Experience may correspond with the larger circle 285b illustrated in FIG. 3, the relative percentage value 290a for Security and Privacy may correspond to the medium circle 290b illustrated in FIG. 3, and the relative percentage value 295a for Mobile Application Development may correspond to the small circle 295b illustrated in FIG. 3.

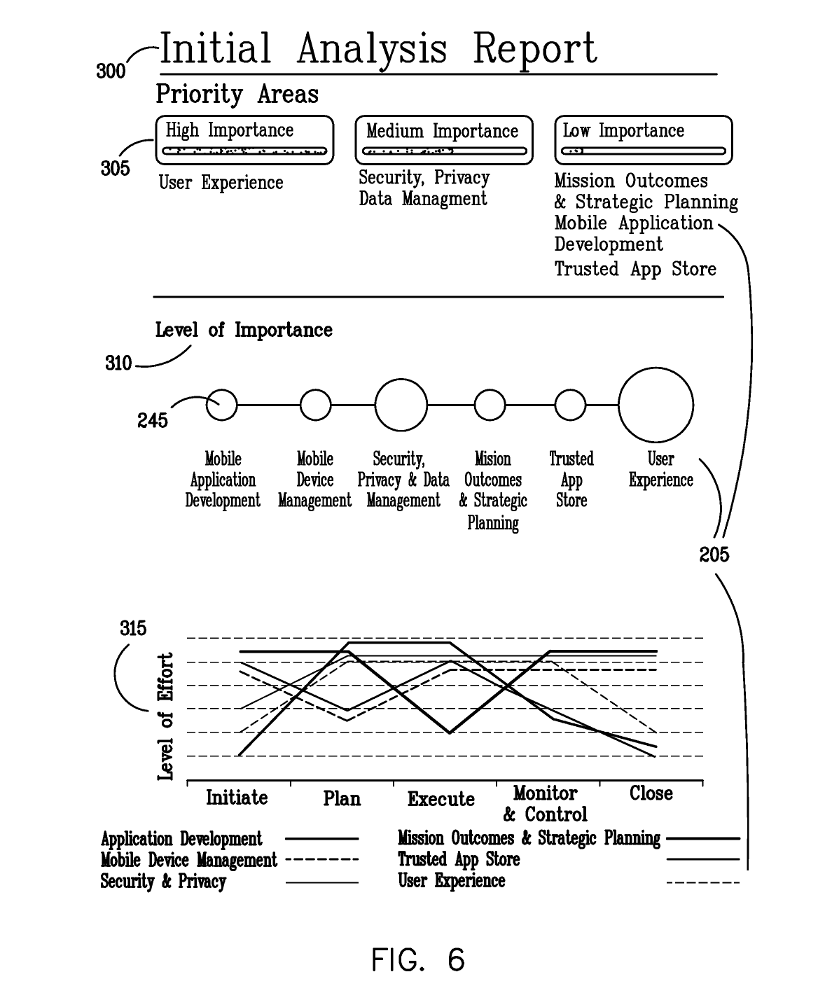

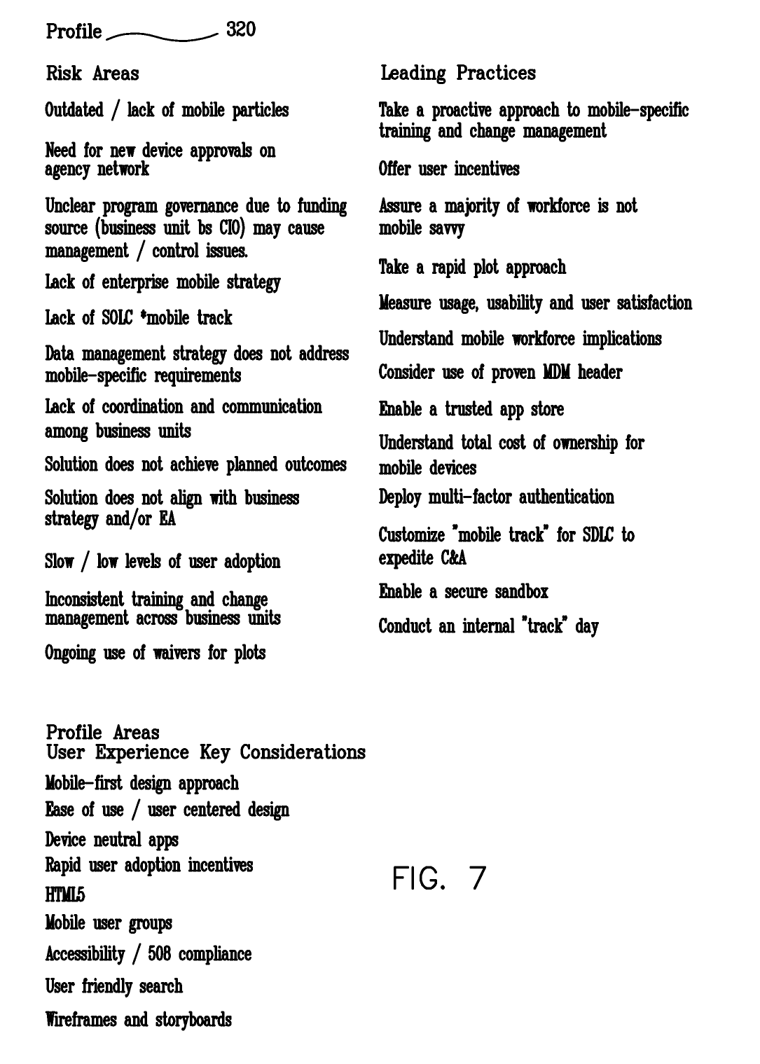

In embodiments, the CreatorLite tool 33 is further configured to generate a report 300 that highlights relevant best practices and risks tailored for the business based on the business's answers to the questions 200 and the calculated relative importance for each functional category or area 205. As shown in FIGS. 6 and 7, the report includes (i) a priority area 305 that provides each category or area 205 listed under the corresponding calculated relative importance; (ii) a level of importance area 310 that provides each category or area 205 with a corresponding object 245 that is increased or decreased in size based on the calculated relative importance; (iii) a level of effort area 315 that displays all of the levels of effort 235 for each category or area 205 in a single graph; and (iv) a profile area 320 tailored specific to the business because the profile area 320 is generated based on the answers 240 provided to the questions 200 and the calculated relative importance for each category or area 205. The profile area 320 may include risk areas for the business's project, leading practices based on the business's project, and prioritized areas of importance for the business's project, which enable the business to effectively and efficiently implement and/or optimize its mobile solution.

At step 115, the business may obtain and/or utilize a tool or application provided and supported by the service provider, which enables the business to obtain a best practices report for implementing and/or optimizing the mobile technology solution within the business. For example, the business may download the CreatorPro tool 34 from a web site, e.g., the Apple Store or the Android Market, onto the computing device 14. Upon operation of the CreatorPro tool 34, the tool is configured to provide an assessment of a business's mobile application initiative by presenting the business with a predetermined number of questions, analyzing the answers provided to the questions by the business, and generating a report that highlights relevant best practices and risks. Specifically, the CreatorPro tool 34 helps the business make sense of hundreds of mobile-related variables and their dependencies on one another. In embodiments, the implementation of the Creator Pro tool 34 enables the business to develop a business mobile strategy that helps get their pilot programs to production in a rapid and cost effective manner. Step 115 may be performed in combination with step 110 or without the performance of step 110.

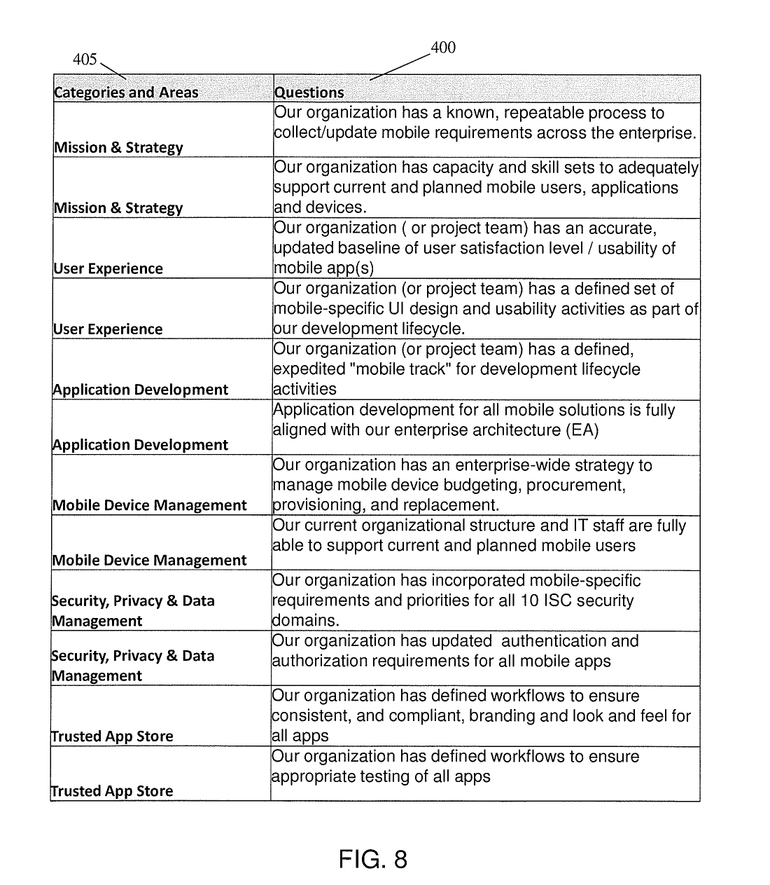

As shown in FIG. 8, the CreatorPro tool 34 is configured to present a predetermined number of questions 400 to the business that relate to the functional categories or areas 405 of a mobile framework used to rapidly assess the business's mobile application initiative. As discussed above, the categories or areas 405 may include: (i) user experience; (ii) security, privacy, and data management; (iii) mission outcomes and strategic planning; (iv) mobile device management; (v) mobile application development; and (vi) trusted application stores.

The business may respond to each of the questions 400 by selecting an answer from a predefined number of possible answers. For example, the business may be asked to respond to each question by selecting whether the business: (i) doesn't know the answer; (ii) strongly agrees with the question; (iii) disagrees with question; (iv) is neutral to the question; (v) agrees with the question; or (vi) strongly agrees with the question. Any number of users that are a member of the business may answer the questions 400 in order to obtain an aggregate collection of answers that represent the business or a specific unit within the business as a whole.

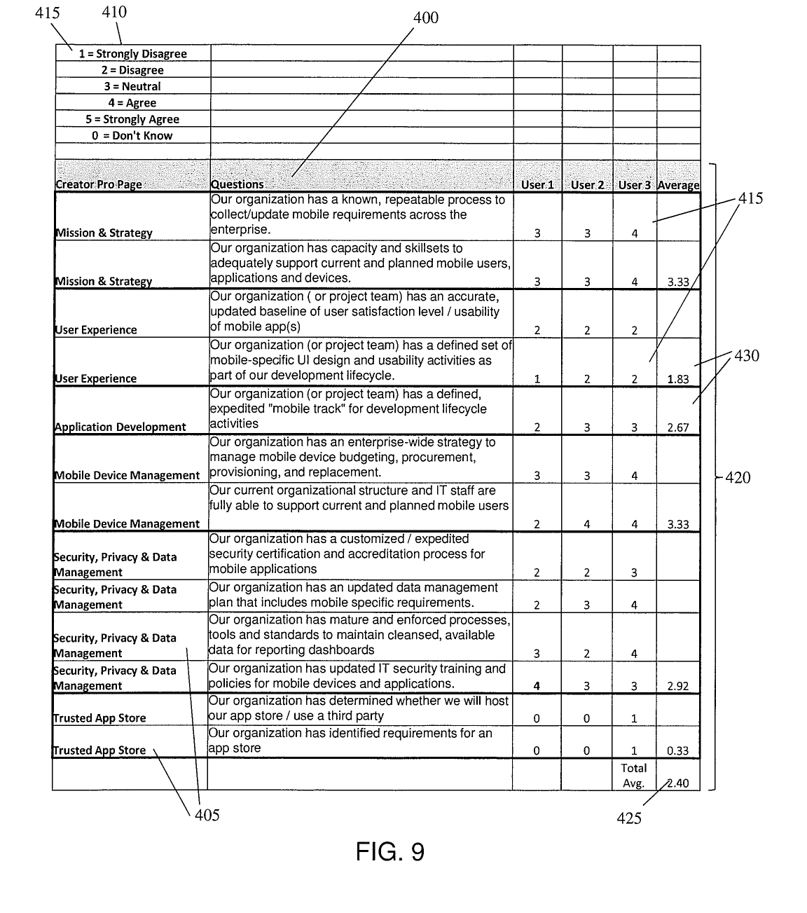

In embodiments, the CreatorPro tool 34 may be configured to calculate a relative maturity level of the business with respect to mobile technology based on the answers supplied by the business to questions 400 by utilizing a database and/or an algorithm. For example, as shown in FIG. 9, each possible answer 410 to questions 400 may be provided a predefined corresponding weight 415 that is inactive of a relative maturity level of the business. As shown in the sample selection area 420, the weights 415 corresponding to selected answers by users 1-3 of the business may be averaged for all of the functional categories or areas 405 to calculate a total average weighted score 425 for the business's overall mobile maturity level. Additionally, the weights 415 corresponding to selected answers may be averaged for each individual category or area 405 to calculate an average categorical weighted score 430.

The total average weighted score 425 and the average categorical weighted score 430 provide an indication of the relative maturity level of the business. For example, a weight of “1” may be indicative that there is evidence that the business has recognized that issues exist and need to be addressed. There are however no standardized processes, but instead there are ad hoc approaches that tend to be applied on an individual or case by case basis. The overall approach to management may be disorganized. A weight of “2” may be indicative that processes have been developed to the stage where similar procedures are followed by different people undertaking the same task. However, there is no formal training or communication of standard procedures, and responsibility is left to the individual. There is a high degree of reliance on the knowledge of individuals and therefore errors may be likely. A weight of “3” may be indicative procedures for mobile planning, implementation and support have been standardized and documented, and communicated through training. It is however left to the individual to follow these processes, and it is unlikely that deviations will be detected. The procedures themselves are not sophisticated but are the formalization of existing practices. A weight of “4” may be indicative that processes have been refined to a level of best practice, based on the results of continuous improvement and maturity modeling with other businesses. Information technology is used in an integrated way to automate the workflow, providing tools to improve quality and effectiveness, making the enterprise quick to adapt. A weight of “5” may be indicative that it is possible to monitor and measure compliance with procedures and to take action where processes appear not to be working effectively. Processes are under constant improvement and provide good practice. Automation and tools are used in a limited or fragmented way. Advantageously, implementation of the above-described questions, answers, and weights rapidly provide a base line maturity level for the business with respect to mobile technology implementation and/or optimization.

In embodiments, the service provider may present the above-described processes with respect to the CreatorPro tool 34, to the business within a workshop environment. For example, the processes executed by the CreatorPro tool 34 may be implemented in conjunction with a full or half day workshop that provides facilitated discussion by the service provider regarding mobile requirements of the business.

At step 120, a detailed report is generated, which provides for each individual category or area 405 a current baseline of the business, findings, recommendations, and best practices for mobility implementation and/or optimization within the business. For example, findings with respect to security, privacy, and data management may include the biggest area of opportunity, based on the questions with lowest average scores and low variability, pertained to defining mobile authentication and authorization requirements. Thus, the recommendations within the report for security, privacy, and data management may include defining mobile-specific authentication and authorization requirements.

At step 125, the business may follow the recommendations in the report and engage with the service provider for an extensive engagement and assessment of the business's mobile requirements. The extensive engagement and assessment may comprise utilizing the assessment tool 30, the MAPIT tool 32, and the usability tool 36. The extensive engagement is a full-scale baseline assessment of a business's mobile maturity. Using a rapid deployment approach, the extensive engagement and assessment takes a short period of time, e.g., 45 days, and provides a business with quantitative and qualitative data for an accurate baseline of the business's maturity in terms of mobile computing.

The extensive engagement and assessment builds on the baseline, findings, and recommendations established using the CreatorPro tool 34 in steps 115 and 120, by utilizing the assessment tool 30, which includes more than 300 predefined questions and weightings. In series or parallel, the business may also collect and prioritize mobile requirements (including non-technical requirements such as policy, budget, change management, etc.) and prioritize requirements using the MAPIT tool 32 in order to identify mobile initiatives with an optimal routine on investment.

In embodiments, the assessment tool 30 is configured similar to that of the of the CreatorLite tool 33 such that the assessment tool 30 is operable to present the business with a set of predefined questions, e.g., more than 300, that are associated with the categories or areas 205/405. For example, a predetermined number of questions pertain to each of the categories or areas 205/405 including: i) user experience; (ii) security, privacy, and data management; (iii) mission outcomes and strategic planning; (iv) mobile device management; (v) mobile application development; and (vi) trusted application stores are presented to the business using the assessment tool 30. The assessment tool 30 is configured to weight each individual question based on the category or area 205/405 that each question is associated with.

The business may answer each question by selecting an answer from a predetermined number of answers. The assessment tool 30 may further be configured to weight each answer. For example, the assessment tool 30 may present the business with four options for answering the questions including: “Don't Know,” “None,” “Partial,” and “Complete.” The assessment tool may provide the answers “Don't Know” and “None” with a weight of “0”, the answer “Partial” with a weight of “1,” and the answer “Complete” with a weight of “2.” Moreover, the assessment tool 30 may further be configured to further weight each question and/or answer based on a previous answer provided to a question.

Once the business has answered the questions, the assessment tool 30 is configured to calculate a relative maturity level of the business with respect to mobile technology based on the answers supplied by the business to the questions by utilizing a database and/or an algorithm. For example, similar to the processes discussed above with respect to the CreatorPro tool 34, the weights corresponding to the answers provided by the users associated with the business and the weights associated with the respective questions may be averaged for all of the functional categories or areas 205/405 to calculate a total average weighted score for the business's overall mobile maturity level. Additionally, the weights corresponding to the selected answers and questions may be averaged for each individual category or area 205/405 to calculate an average categorical weighted score for each category or area 205/405.

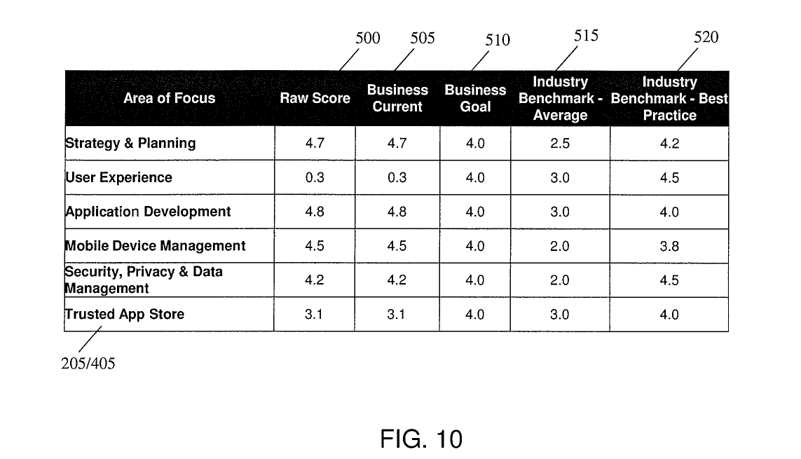

The assessment tool 30 may be further configured to generate a detailed report that provides for each individual category or area 205/405 a full-scale baseline assessment, findings, recommendations, and best practices for mobility implementation and/or optimization within the business. For example, as shown in FIG. 10, the assessment tool 30 may be configured to provide the calculated average categorical weighted score 500 for each individual category or area 205/405 in a chart format or graph, which illustrates the business's current baselines 505 for each individual category or area 205/405, the business's goals 510 (which may be provided by the business or the service provider) for each individual category or area 205/405, an industry benchmark average 515 (which may be provided from a historical database of the service provider), and a industry benchmark best practice 520 (which may also be provided from the historical database of the service provider). The historical database may comprise data, e.g., calculated baselines for other businesses, collected from executing the processes of the claimed invention with other business over a period of time.

The business's mobile strategy may then be refined throughout the business's mobile implementation and/or optimization project based on the data collected using the assessment tool 30 and the feedback provided in the report. The generated chart and graph may be utilized to monitor and grade performance of the mobile strategy. Specifically, assessment tool 30 enables the business to get an immediate understanding of the business's maturity, business objectives, stakeholder requirements, performance metrics and next steps to be taken in the individual categories or areas 205/405 in order to implement and/or optimize the business's mobile strategy.

In embodiments, the business may also use the MAPIT tool 32 in order to identify mobile initiatives with optimal return on investment. For example, the MAPIT tool 32 may be configured to define criteria using a four-quadrant framework to enable the business to prioritize its requirements based on technical complexity and customer value.

In embodiments, the business may also use the usability tool 36 in order to evaluate the usability of mobile devices and/or applications using tests, scorecards, and best practices to increase ease of use for mobile solutions. Specifically, the usability tool 36 is configured to provide a set of tools specific to user ability and not synonymous with user testing.

At step 130, the business may follow the recommendations provided in the report generated using the assessment tool 30. During implementation of the business's mobile implementation and/or optimization strategy, the business may also utilize the mPMO tool 37, which provides support to the business with effective management and ongoing performance improvement of the business' mobile initiatives. The mPMO tool 37 is built on the foundation of the previous work products (i.e., mobile maturity baseline, prioritized mobile requirements, performance measures, business mobile strategy, and implementation roadmap). For example, the mPMO tool 37 may be configured to build the business's mobile case(s), monitor performance, assist in moving pilot programs into production, develop mobile policies, and optimize the business's system development life cycle activities (such as security and accreditation) for mobile development and deployment.

At step 135, the business may measure its performance of developed mobile strategy utilizing the mPMO tool 37. For example, the mPMO tool 37 is configured to ensure that the business's mobile computing supports the business's mission and saves the business money by implementing and optimizing a mobile strategy in an efficient and effective manner.

At step 140, the business may train in house mobile application developers using the application training tool 35. For example, the application tool 35 is configured to train mobile application developers and managers in the design of mobile applications on multiple platforms, e.g., the Android and iOS platforms. In embodiments, the service provider may present training for the design of applications with respect to the application tool 34, to the business within a workshop environment. For example, processes executed by the application tool 34 may be implemented in conjunction with a two or four day workshop that provides facilitated discussion by the service provider regarding design of applications on the Android and iOS platforms.

As should be understood from the above described processes of the claimed invention, not all mobile initiatives will yield cost savings for businesses, and may not in the first year. Consumer mobile devices are inherently less expensive than devices that have been designed to operate exclusively in a specific business environment, such as the Secure Mobile Environment Portable Electronic Device (SME PED). However, today most consumer mobile devices will require the addition of third party security products and infrastructure tools to meet the security and policy requirements for their use in Government and Business production environments. There are a multitude of COTS products and device augmentation processes that can be examined to determine what is the most appropriate combination of measures to elect for a given use case(s).

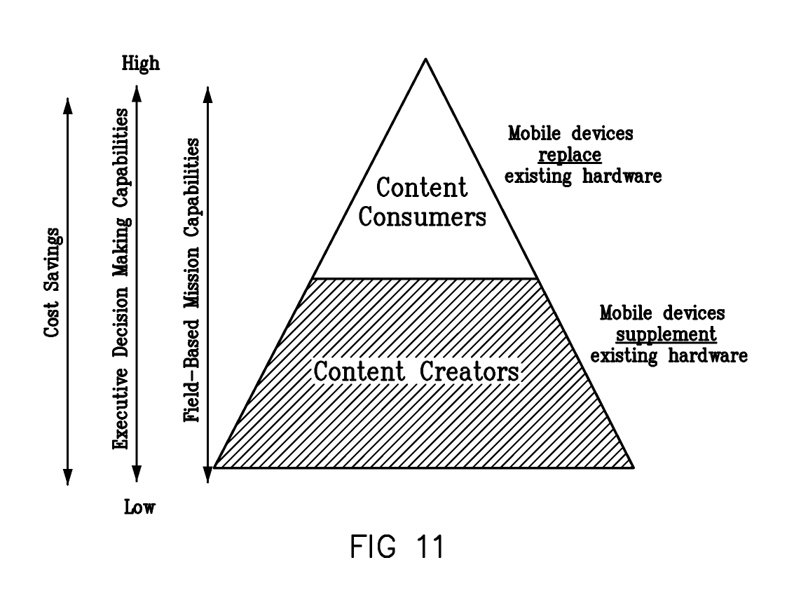

Businesses need to define and prioritize mobile requirements, conduct rigorous due diligence, collect business case data, develop analysis of alternatives, identify pilots with highest ROI and strategically develop a mobile portfolio. If cost savings is the primary driver for a business, then it is critical that the business understand its user base in terms of “content consumers” and “content creators,” as illustrated in FIG. 11. Content consumers most often include executives or senior management in a business. This user base requires a device to access email and the internet, and review content or application dashboards. Content consumers are optimal targets for cost savings to the business because their current devices (laptops/desktops) can most likely be replaced by mobile devices. Content creators are users who create the content (e.g., word documents, presentations, spreadsheets, process diagrams, project plans, etc.) or enter structured or unstructured data and/or multi-media digital assets into applications (e.g., data entry, photos, videos, etc.).

For content creators, an important distinction is whether users are based at headquarters or in the field for most of their work. The business case for content creators who are located at headquarters, with little travel, will in all likelihood show that desktop/laptop computers are optimal. Content creators located in the field, or who travel for a majority of their work, are also good candidates for mobile cost savings.

Many users in an business will be both content consumers and content creators, and in these cases cost savings may be derived from sources other than hardware replacement. For example, if it is determined from the use of the above mentioned tools and processes that users would search for/access work-related manuals on a mobile device; this could result in cost savings as a result of lower printing costs for large numbers of users. Estimated printing costs may range from $220-$300 per user. However, estimated savings from mobile must be realistic, based on user-feedback and estimated adoption rates. Small pilots are best to test assumptions and mobile functionality in order to identify user issues that will prevent rapid adoption.

Advantageously, beyond cost savings, the above described tools and processes may benefit a business by improving executive decision making capabilities/information access, enhancing field-based mission capabilities, increasing user satisfaction, increasing operational efficiency, helping with recruitment and retention of workforce, and enhancing a business's brand.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principals of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

What is claimed is:

1. A method implemented in a computer infrastructure having computer executable code tangibly embodied on a computer readable storage medium having programming instructions operable to:
assess a current mobile technology baseline for a business using a tool or application and a processor; and
provide a strategy to the business for at least one of adopting and optimizing use of mobile technology.

2. The method of claim 1, wherein the mobile technology comprises a mobile application.

3. The method of claim 1, wherein the programming instructions are further operable to:
assess a mobile application initiative of the business by presenting a predetermined number of questions that relate to functional categories of a mobile framework;
analyze answers provided by the business to the questions; and
generate a report that highlights relevant best practices and risks relevant to the mobile application initiative.

4. The method of claim 3, wherein the functional categories comprise: (i) user experience; (ii) security, privacy, and data management; (iii) mission outcomes and strategic planning; (iv) mobile device management; (v) mobile application development; and (vi) trusted application stores.

5. The method of claim 4, wherein the analyzing the answers provided by the business to the questions comprises:
providing each possible answer to the questions with predetermined weights that are indicative of a relative importance of that answer to each of the functional categories;
summing all of the predetermined weights corresponding to the answers provided by the business to obtain total weighted score;
summing all of the predetermined weights corresponding to the answers provided by the business and each of the functional categories to obtain a total categorical weighted score for each of the functional categories; and
dividing each of the total categorical weighted scores by the total weighted score and multiplying by a factor to obtain a relative percentage value for each of the functional categories.

6. The method of claim 5, wherein the programming instructions are further operable to change a display of a plurality of objects to depict the calculated relative percentage values for each of the functional categories.

7. The method of claim 6, wherein the report includes the display of the plurality of objects.

8. The method of claim 1, wherein the programming instructions are further operable to:
assess a mobile application initiative of the business by presenting a predetermined number of questions that relate to functional categories of a mobile framework;
analyze answers provided by at least one user associated with the business to the questions; and
generate a report that provides a current baseline of the business, findings, recommendations, and best practices for mobility implementation and/or optimization within the business.

9. The method of claim 8, wherein the functional categories comprise: (i) user experience; (ii) security, privacy, and data management; (iii) mission outcomes and strategic planning; (iv) mobile device management; (v) mobile application development; and (vi) trusted application stores.

10. The method of claim 9, wherein the analyzing the answers provided by the business to the questions comprises:
providing each possible answer to the questions with predetermined weights that are indicative of a relative maturity level of the business;
averaging all of the predetermined weights corresponding to the answers provided by the at least one user to obtain total average weighted score; and
averaging all of the predetermined weights corresponding to the answers provided by the at least one user and each of the functional categories to obtain an average categorical weighted score for each of the functional categories.

11. The method of claim 10, wherein the total average weighted score provides an overall maturity level of the business, and the average categorical weighted score provides a maturity level of the business for each of the functional categories.

12. The method of claim 1, wherein a service provider at least one of creates, maintains, deploys and supports the computer infrastructure.

13. The method of claim 1, wherein the steps of claim 1 are provided by a service provider on a subscription, advertising, and/or fee basis.

14. A computer program product comprising a computer usable storage medium having readable program code embodied in the storage medium, the computer program product includes at least one component operable to:
assess a current mobile technology baseline for a business; and
provide a strategy to the business for at least one of adopting and optimizing use of mobile technology.

15. The computer program product of claim 14, wherein the at least one component us further operable to:
assess a mobile application initiative of the business by presenting a predetermined number of questions that relate to functional categories of a mobile framework;
analyze answers provided by the business to the questions; and
generate a report that highlights relevant best practices and risks relevant to the mobile application initiative.

16. The computer program product of claim 15, wherein the functional categories comprise: (i) user experience; (ii) security, privacy, and data management; (iii) mission outcomes and strategic planning; (iv) mobile device management; (v) mobile application development; and (vi) trusted application stores.

17. A computer system for to rapidly assessing a business's mobile application initiative, the system comprising:
a CPU, a computer readable memory and a computer readable storage media;
first program instructions to assess a current mobile technology baseline for a business; and
second program instructions to provide a strategy to the business for at least one of adopting and optimizing use of mobile technology,
wherein the first and second program instructions are stored on the computer readable storage media for execution by the CPU via the computer readable memory.

18. The system of claim 17, further comprising:
third program instructions to assess a mobile application initiative of the business by presenting a predetermined number of questions that relate to functional categories of a mobile framework;
fourth program instructions to analyze answers provided by the business to the questions; and
fifth program instructions to generate a report that highlights relevant best practices and risks relevant to the mobile application initiative.

19. The system claim 18, wherein the functional categories comprise: (i) user experience; (ii) security, privacy, and data management; (iii) mission outcomes and strategic planning; (iv) mobile device management; (v) mobile application development; and (vi) trusted application stores.

20. A method comprising:
receiving a communication expressing interest from a business with respect to implementing or optimizing a mobile technology;
implementing a first tool using a processor to rapidly assess a business's mobile application initiative and generate a best practices report;
implementing a second tool using the same processor or another processor to obtain a baseline maturity level for the business and generate a report that includes baselines, findings, and recommendations for implementing or optimizing the mobile technology;
executing the recommendations;
implementing a third tool to perform an extensive assessment of the business's mobile requirements;
developing a mobile strategy and implementation plan utilizing a fourth tool; and
measuring performance of the developed mobile strategy using the fourth tool.
